(19) United States
(12) Patent Application Publication
(10) Pub. No.: US 2009/0266433 A1
(43) Pub. Date: Oct. 29, 2009

(54) Faucet

(76) Inventor: Ron Liang, Xiamen (CN)

Correspondence Address: Dr. BANGER SHIA;Int''l Patent Office of Bang Shia, 102 Lindencrest Ct, Sugar Land, TX, 77479-5201, US

(21) Appl. No.: 12/109,499

(22) Filed: Apr. 25, 2008

(51) Int. Cl. B67D 5/37

(52) U.S. Cl. 137/801

(57) ABSTRACT

A faucet is formed with at least an inner waterway support layer, a middle filling layer, and an outer organic plastic layer. The inner waterway support layer is made of a material without any heavy metal; the middle filling layer wraps around the inner waterway support layer, being formed with an organic plastic and a filler. The faucet is formed with the inner waterway support, in which the support is made of a material without lead. The copper is not applied; even if being applied, the copper is applied in only a middle section of waterway of the faucet. Another low-cost filler is applied in most of the sections of the outer layer, thereby the cost being significantly reduced. The material is poor in heat conductivity and rich in heat insulation, preventing the faucet from scalding a user; the heat loss may be reduced for economy energy and environmental protection.

### BACKGROUND OF THE INVENTION

1. Field of the Invention

This invention relates to a bathroom device and particularly to a faucet.

2. Description of Related Art

In the plumbing industry, being easily processed, the brass may be teemed for various forms. The brass has preferable inertia and thus is not easily dissolved in water and apt to rust, so a faucet that is molded with the brass and then machined is widely applied in the industry. However, the following issues are caused by the faucet made of the brass.
1. Being high in a melting point and poor in fluidity, the native copper has a disadvantage in molding; being soft, the native copper has a disadvantage in machining after being molded. Thus, the brass as a copper alloy is used in the industry. Such a copper alloy typically contains lead and cadmium as heavy metals. After contacting water for a long time, part of the heavy metal is dissolved in water; if people drink the water, they are harmed, and if the water is discharged, the environment is polluted, being disadvantageous to environmental protection. Thus, in Euro-American countries, the lead contained in the brass and precipitated in water is strictly restricted. For example, the NSF certification is required in North America; the WRAS certification is required in England; the KTW certification is required in German; the ACS certification is required in France. Currently, in the industry, in the art of lead washing, a chemical solution is used to scour off the lead of heavy metal on the surface for achievement of the NSF request; the method is not secure and easily fails, the cost of which is higher. Further, zero lead will completely implemented in the plumbing industry of North America in year 2010, and materials contacting water that contains the lead of heavy metal are not accepted, which impacts very much the plumbing industry.
2. Due to the reserves that are limited and the price of copper that rise at a higher speed in recent 3 years more than three times, the costs of materials in the plumbing industry increase significantly.
3. The copper is capable of heat conductivity, so when hot water flows through the faucet made of the brass, the heat is very fast transmitted to the surface of faucet and easily scalds a user. Besides, heat loss and energy consumption are higher and the environmental protection is not considered; namely, the copper-made faucet is not capable of heat insulation.

Consequently, because of the technical defects of described above, the applicant keeps on carving unflaggingly through wholehearted experience and research to develop the present invention, which can effectively improve the defects described above.

### SUMMARY OF THE INVENTION

In order to solve technical issues mentioned above, this invention provides a significantly low-cost faucet that is made of lead of heavy metal and capable of heat insulation.

In order to achieve the object, the following approach of technology is applied.

A faucet is formed with at least three layers, namely, an inner waterway support layer, a middle filling layer, and an outer organic plastic layer. The inner waterway support layer is made of a material without any heavy metal; the middle filling layer wraps around the inner waterway support layer, being formed with an organic plastic and a filler.

The inner waterway support layer is made of a stainless-steel copper or plastic material without any heavy metal.

The plastic material is POM or PPO.

The specific gravity of middle filling layer after mixed is in 2.0˜5.5 g/cm3.

The organic plastic in the middle filling layer is ABS, PPO, PC, PP, or PE.

The filler in the middle filling layer is kaolin, calcium carbonate, or metallic mineral.

The material in the outer organic plastic layer is ABS or Nylon.

The surface of outer organic plastic layer is electroplated, sprayed and coated, and baked for varnish.

Multiple layers of middle filling layers are formed between the inner waterway support layer and the outer organic plastic layer to satisfy the requirements of product molding and quality.

In the manner, the faucet cast with only one layer of copper according to this invention is improved and then formed with a three-layer structure; thus, at least the following advantages are given.
1. Consideration of environmental protection: The faucet according to this invention is formed with the inner waterway support that contacts water, in which the support is made of a material without any heavy-metal lead, such as a stainless-steel material, a plastic material, or copper without any heavy metal for achievement of environmental protection requested in western countries.
2. Significantly low cost: The price of copper is higher, so the costs of materials applied in the plumbing industry are higher than that of an integrated product by 50%. The copper is not absolutely applied to the product according to this invention; even if being applied, the copper is applied in only a middle section of waterway of the faucet; another low-cost filler is applied in most of the sections of the outer layer.
3. Preferable heat insulation: The middle filling layer occupying a majority of materials applied to the faucet according to this invention is formed with the organic plastic and the filler that are mixed together; the material is poor in heat conductivity and thus rich in heat insulation, preventing the faucet from scalding the user; besides, the heat loss may be reduced for achievement of economy energy and environmental protection.
4. Various casts and shapes of faucet: The plasticity of outer organic plastic layer is strong so that the faucet may be molded in various forms.
5. Achievement of the high texture of copper for increased product selling point: The specific weight of mixture in the middle filling layer may be set to 2.0˜5.5 g/cm3 in this invention or set depending on requirements or a filling layer may be added depending on the structure of a product so that the high texture of faucet in whole may be achieved as that of copper.
6. Diverse surface treatment: The outer organic plastic layer is made of a material that is easily electroplated, sprayed and coated, or banked for varnish, such as ABS or nylon, so that the surface may be electroplated or sprayed and coated with various colors to satisfy consumers with individuation.

### BRIEF DESCRIPTION OF THE DRAWINGS

FIG. 1 is a schematic view illustrating the structure of this invention.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

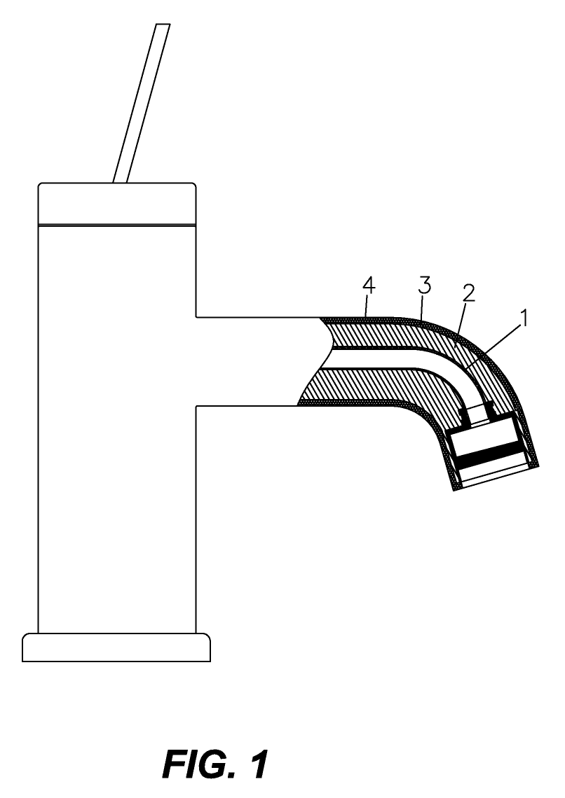

As shown in FIG. 1, a faucet according to this invention is formed with at least three layers, namely, an inner waterway support layer 1, a middle filling layer 2, and an outer organic plastic layer 3.

The inner waterway support layer 1 is provided for a waterway and hollow where the waterway is formed. The inner waterway support layer is made of a stainless-steel copper or plastic material without any heavy metal. The plastic material may be POM or PPO. Stainless steels and plastics do not contain any heavy metal and the used copper does not also contain any heavy-metal copper element so as to satisfy western countries with environmental protection without lead.

The middle filling layer 2 wraps around the inner waterway support layer 1, being formed with an organic plastic and a filler that are mixed together in a preferable specific weight of 2.0˜5.5 g/cm³, which makes the texture of faucet high as that of copper. The organic plastic may be ABS, PPO, PC, PP, or PE, while the filler may be kaolin, calcium carbonate, or metallic mineral, such as iron mine.

The outer organic plastic layer 3 wraps around the middle filling layer 2 and may be made of ABS or Nylon.

Further, the outer organic plastic layer 3 may be electroplated with one layer of electro-deposited coating 4 for the texture of various colors or metallic form and thus pleasant impression of the appearance of product. Certainly, it may also be sprayed and coated with various colors or processed with baking varnish likewise for enhancement of the good look of product.

Next, multiple layers of middle filling layers 2 are formed between the inner waterway support layer 1 and the outer organic plastic layer 3 to satisfy the requirements of product molding and quality.

At the time of manufacturing, the inner waterway support layer 1 is first processed and then the mixed middle filling layer 2 is cast outside, and next the outer organic plastic layer 3 is molded In this invention, the two manners of casting are applied for the purposes of easy formation, low-cost manufacturing, and large yield.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A faucet comprising at least three layers, namely, an inner waterway support layer, a middle filling layer, and an outer organic plastic layer, in which the inner waterway support layer is made of a material without any heavy metal and the middle filling layer wraps around the inner waterway support layer, being formed with an organic plastic and a filler.

2. The faucet according to claim 1, wherein the inner waterway support layer is made of a stainless-steel copper or a plastic material without any heavy metal.

3. The faucet according to claim 2, wherein the plastic material is POM or PPO.

4. The faucet according to claim 1, wherein the specific gravity of middle filling layer after mixed is in 2.0˜5.5 g/cm³.

5. The faucet according to claim 1, wherein the organic plastic in the middle filling layer is ABS, PPO, PC, PP, or PE.

6. The faucet according to claim 1, wherein the filler in the middle filling layer is kaolin, calcium carbonate, or metallic mineral.

7. The faucet according to claim 1, wherein the outer organic plastic layer is made of ABS or Nylon.

8. The faucet according to claim 1, wherein the surface of outer organic plastic layer is electroplated, sprayed and coated, and baked for varnish.

9. The faucet according to claim 1, wherein multiple layers of middle filling layers are formed between the inner waterway support layer and the outer organic plastic layer.
